(19) United States
(12) Patent Application Publication
(10) Pub. No.: US 2011/0056779 A1
(43) Pub. Date: Mar. 10, 2011

(54) HIGH PERFORMANCE ADHESIVES AND METHODS FOR THEIR USE

(75) Inventors: John D. McGee, Troy, MI (US); Stefan Kreiling, Duesseldorf (DE); Stanley Leroy Lehmann, Martinez, CA (US); Andreas Taden, Duesseldorf (DE)

(73) Assignees: Henkel Corporation, Rocky Hill, CT (US); Henkel AG & Co. KGaA, Duesseldorf (DE)

(21) Appl. No.: 12/945,256

(22) Filed: Nov. 12, 2010

Related U.S. Application Data
(63) Continuation of application No. PCT/US2009/049229, filed on Jun. 30, 2009.
(60) Provisional application No. 61/076,917, filed on Jun. 30, 2008.

(51) Int. Cl. F16D 65/00; B32B 3/10; B32B 37/12; F16D 65/097; F16D 65/092

(52) U.S. Cl. 188/250 E; 428/141; 156/325

(57) ABSTRACT

The present invention is directed to benzoxazine-containing adhesives having high adhesive strength at high temperature. These materials are especially useful in automotive applications, in particular, as adhesives for brake components. Methods of their use are also described.

### FIELD OF THE INVENTION

The invention relates to benzoxazine-containing adhesives useful for high temperature applications, including use in adhering vehicle components such as brake assemblies.

### BACKGROUND OF THE INVENTION

High performance adhesives are useful materials in the automotive field, as well as in other fields. For example, adhesives are required that can withstand high shear in a high temperature environment. In other applications, adhesives that maintain bonding at high temperature under other mechanical stresses, for example, vibrational stresses, are desirable. In particular, vehicle brake components, such as shims and brake pads, must withstand these rigorous conditions.

Phenolic-based resins have been the industry standard for adhesive applications within the braking industry for over fifty years due to their low cost and good mechanical and heat resistance properties. But despite their long-standing use, these phenolic-based resins have several disadvantages. The most notable is that as these resins cure, they release volatile by-products that, if not effectively managed or eliminated, result in the formation of “bubbles” and “voids” in the adhesive layer that decrease the strength of the resultant bond. Application of pressure during the curing stage is one method of facilitating the removal of the volatile by-products; however, phenolic-based adhesive strength is susceptible to changes in applied pressure. Typically, it is necessary to experiment with the amount of applied pressure to achieve a preferred curing pressure. In one-stage curing applications, the strength of the initial bond will be affected, resulting in, for example, a reduction in shear strength. In two-stage curing applications, while the first stage bond might be acceptable, the second stage bonding may result in loss of adhesive strength, rather than a gain.

Additionally, phenolic resins, in particular resole resins, require refrigerated storage conditions to retard the premature curing of the resin. Moreover, phenolic resins are frequently supplied in a solvent vehicle to facilitate application of the resin. The solvent must subsequently be removed, resulting in the release of volatile organic compounds (“VOCs”), which is environmentally undesirable. In addition, removal of the solvent can sometimes result in solvent vapor pockets developing in the adhesive, resulting in a weaker bond.

Another drawback to the use of solvent with phenolic-based resins is that during the solvent removal process, the phenolic-based resins begin to cure and become less supple. As a result, application of the phenolic-based adhesive is more difficult. To offset the decreased workability, elastomers are frequently added to solvent-based phenolic resin systems. The addition of elastomers facilitates the application of the phenolic-based resin after solvent removal. But while the elastomers assist in the application of the phenolic-based resins, they compromise the shear strength of the adhesive bond at high temperatures.

Elastomer-modified phenolic-based adhesives are also used for applications wherein vibrational dampening is desired. The prior art has found that resins that include elastomeric materials not only have adhesive properties, but also have desirable vibrational dampening properties. But while the elastomers contribute to desirable vibrational dampening, as described above, phenolic-based resins containing elastomeric materials suffer a decrease in bond strength at high temperatures.

As such, there is a need for an adhesive, suitable for use in a vehicle brake component, that imparts high shear strength, without releasing volatile materials during curing and that retains bond strength at high temperatures even with the addition of elastomeric materials.

### SUMMARY OF THE INVENTION

The present invention is directed to benzoxazine-containing adhesives and their use in applications requiring high shear strength under high temperature conditions. The invention is also directed to benzoxazine-containing adhesives and their use in vibrational damping applications. In particular, the invention is directed to vehicle components comprising a material adhered to a substrate using a benzoxazine-containing adhesive. Methods of adhering materials to a substrate are also described.

### DETAILED DESCRIPTION OF THE INVENTIONS

The present invention is directed to adhesives comprising at least one benzoxazine-containing compound, and in particular, the use of such adhesives in vehicle components that are subjected to high temperatures, as well as high shear or other mechanical stresses. Adhesively-bonded vehicle brake components, for example, shims and brake pads, are exemplary vehicle components that may be used with the adhesives of the present invention. The present invention is also applicable to vehicle transmission components.

For the purposes of this specification, a benzoxazine compound is one that contains at least one of the structure:

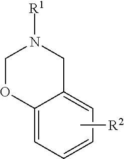

in which R¹ and R² may be any organic moiety, including another benzoxazine structure.

These adhesives require no specialized storage conditions and can be applied to a material or substrate without the need of a solvent vehicle, although a solvent vehicle can be used if desired. In addition, these adhesives result in a bonded component exhibiting a high shear strength under high temperature conditions. This high bond strength is observed with the materials of the present invention even upon addition of elastomeric materials.

The adhesives of the present invention are suitable in both single stage cure applications, for example, those applications where the adhesive achieves substantial curing at the initial bonding step. The present adhesives are also suitable in two-stage cure applications, as well as any other applications in which the adhesive does not achieve substantial curing at the initial bonding step, but achieves substantial curing at a different time and/or location.

It is envisioned that these adhesives will be suitable for use in any adhesive application where adhesive strength at high temperatures is required, for example, temperatures greater than 300° F. (about 149° C.), more typically about 400° F. (about 204° C.). In preferred embodiments, the adhesives of the present invention are suitable for use at temperatures of between about 100° C. and about 250° C., more particularly between about 150° C. and about 210° C. In other embodiments, the present adhesives are suitable for at least short-term exposure use at 300° C. Adhesives of the present invention are suitable for use in those applications requiring a sustained adhesive bond at high temperatures for an extended time period, as well as those applications requiring shorter exposure times to high temperatures.

In particular, the adhesives of the invention may be used in those applications requiring high shear resistance under high temperature. Exemplary applications where the adhesives of the present invention are suitable are use in the friction assembly field, in particular, the vehicle brake component field. In preferred embodiments, a brake component typically comprises a friction material adhered or mounted onto a substrate to form a friction element. Examples of brake components are those used in the vehicle brake field, for example, automobile, truck, aircraft, train, and motorcycle brakes. Brakes can be either “disk” or “drum” type brakes. A typical disk brake includes a rotating element (“brake disk”) and a friction material (“lining”) bonded or adhered to a metal substrate, ideally a metal plate (collectively, a “brake pad”). In most cases, two brake pads fit into a caliper assembly and press against both sides of the brake disk to effect the slowing and/or stopping of the vehicle. A typical drum brake comprises a rotating drum and a metal substrate bonded to a friction material (“brake shoe”). Slowing and/or stopping is effected by the brake shoe pressing against the internal surface of the drum. Significant forces, for example shear and other mechanical forces such as vibrational forces, are involved in braking applications. Due to the relative movement during engagement, extreme heat may be generated upon braking. Moreover, depending upon the size and/or the payload carried by the vehicle, the brake assembly may also be subject to significant pressure, vibration, and the like when stopping the vehicle.

Other examples of vehicle components include friction elements used in transmission components, for example transmission bands and clutch rings and disks. In such assemblies, a friction material-coated paper is bonded to metal components.

The friction materials suitable for use in the present invention may vary in composition depending on the application and other considerations. In general, friction materials within the scope of the invention include any materials that can withstand the high shear and temperatures encountered in a brake assembly. For example, friction materials comprising asbestos, carbon, and resin are suitable for use with the present invention. In addition, semi-metallic friction materials are also suitable for use with the present invention, for example, those comprising an amalgam of bronze, copper, iron, and steel wool held together with a bonding agent. Ceramic-metal based friction materials can also be used.

In contrast to known phenolic resin-based adhesives, the adhesives of the present invention do not require the application of high pressures during curing, as the instant adhesives do not release volatiles during the curing phase. As a result, the adhesives presently described are useful in applications involving porous materials, such as certain friction materials. Less absorption into the porous material due to lower pressures during curing results in more adhesive being available to bond. In addition, the adhesives of the present invention are not susceptible to changes in curing pressures. With the adhesives of the present invention, only pressure sufficient to provide physical contact of the materials to be adhered may be required. In preferred embodiments, a pressure of between about 10 and about 200 psi is sufficient. In other embodiments, about 50 to about 200 psi is sufficient. In still other embodiments, about 10 to about 50 psi, in particular, about 10 to about 20 psi of pressure is sufficient.

One aspect of the present invention is the high strength exhibited and maintained at elevated temperatures of the vehicle components utilizing the benzoxazine-containing compounds. Prior art based nitrile-phenolic adhesives used in assemblies such as brake components are capable of high levels of shear strength, but such strength declines as a function of temperature and/or time. “Shear strength” is the force required to separate two substrates as they slide across each other. Shear strength may be determined by known methods in the art, including SAEJ840. When bonding metal, in particular steel, to friction materials, failure frequently occurs within the friction material. As a result, bonding of metal to metal provides data regarding the strength, including the failure, of the adhesive and serves as a useful means to gauge the bond strength of the adhesive. Unless otherwise noted, shear strength values herein are based on metal to metal bonding.

Embodiments of the present invention exhibit high shear strength at elevated temperatures. Preferred embodiments exhibit shear strengths of at least about 1500 psi at about 204° C. Exemplary embodiments of the present invention exhibit shear strengths of about 2500 to about 3000 psi at about 204° C. Other exemplary embodiments exhibit shear strength of at least 2500 psi at about 204° C. Particularly preferred are those embodiments that exhibit a shear strength of at least about 2800 psi or at least about 2850 psi at about 204° C. The adhesives of the present invention also exhibit high shear strengths at ambient temperature. For example, some embodiments exhibit shear strengths of at least 4000 psi at about 21° C. Particularly preferred are those adhesives exhibiting a shear strength of about 6100 psi at about 21° C.

Within the scope of the present invention, “high shear strength” may also be determined for certain embodiments as an expression of the ratio of the shear strength at 400° F. (about 204° C.) to the shear strength at ambient temperature (about 70° F.; about 21° C.) (“shear strength ratio”). Preferably, the adhesives of the present invention exhibit a shear strength ratio of at least about 0.4. More preferably, the adhesives of the present invention exhibit a shear strength ratio of at least about 0.5. In more preferred embodiments of the present invention, the ratio is at least about 0.6. Most preferred are those embodiments exhibiting a ratio of at least about 0.7.

Other embodiments of the present invention include those adhesives having a high peel strength. “T-Peel Strength” is the average load per unit width of a bond line required to separate bonded materials wherein the angle of separation is 90 degrees. Methods for determining peel strength are known in the art and include, for example, ASTM D903 and ASTM D3807. The adhesives of the present invention exhibit peel strengths of about 20 PLI to about 75 PLI. Particularly preferred are those embodiments that exhibit a peel strength of about 50 to about 75 PLI, more preferably about 54 to about 66 PLI, when exposed to ambient conditions. In some embodiments, the components are bonded and then subjected to heat, typically about 250° C. for about 30 minutes and then cooled to ambient temperature (about 21° C.). Adhesives of the present invention exhibit a post-heat peel strength of about 20 to about 75 PLI, more preferably about 25 to about 65 PLI.

The adhesives of the present invention are also suitable for adhering other vehicle components. For example, when the friction material of a vehicle brake contacts the rotor in order to initiate the stopping or slowing of a vehicle, this action causes vibration of the brake assembly. This vibration can result in noise. In certain applications, “shims” are used within the brake assembly to control this noise. Shims are generally made of a metal plate, preferably steel or stainless steel, to which damping material layers have been applied, either to two sides of the plate or one side of the plate. The metal plate is generally about 500 to about 550 microns thick. In many cases, the damping material layer is comprised of rubber, for example, silicon rubber or nitrile rubber; however, nonmetal fibers, for example, glass fibers, ceramic fibers, rock wool, mineral wool, fused quartz fiber, chemical processed high silica fiber, fused alumina silicate fiber, alumina continuous fiber, stabilized zirconia fiber, boron nitride fiber, alkalki titanate fiber, whiskers, boron fiber, and the like; fillers, for example, inorganic fillers such as clay, talc, barium sulfate, sodium bicarbonate, graphite, lead sulfate, tripoli, wollastonite, and the like; organic fillers; and other elastomers can also be present. The rubber may be styrene-butadiene rubber, acylonitrile-butadiene rubber (nitrile rubber), isoprene rubber, chloroprene rubber, butadiene rubber, isobutylene-isoprene rubber, silicone rubber, chlorosulfonated polyethylene, ethylene-vinylacetate copolymers, chlorinated polyethylene, chloro-isobutane-isoprene rubber, epichlorohydrin rubber, nitrile isoprene rubber, and the like. Shims must withstand the high temperature environment of a vehicle brake assembly, while at the same time, be able to withstand the mechanical forces, for example vibrational forces, associated with the application of those assemblies.

A shim can be applied to a brake pad using any of the techniques known in the art. Typically, the shim is adhered to the back plate of the brake assembly. Over time, as the brake assembly is activated, heat is generated during the in-service use of the vehicle. With the adhesives of the present invention, this results in a strong bond between the back plate and the rubber of the shim. This is in contrast to the phenolic-based adhesives that can fail upon in-service use. While not wishing to be bound to any particular theory, the phenolic-based resins generate volatile by-products upon curing. During in-service use, the phenolic-based adhesives achieve a more significant amount of cure than that achieved during the initial bonding of the shim to the brake pad. This further curing results in the generation of volatile by-products, which, when not effectively managed, over time, tend to weaken the phenolic-based adhesive bond. In contrast, no volatile by-products are produced during the curing of the benzoxazine-based adhesives of the present invention; therefore, there are no volatile-by-products produced that would further weaken the adhesive bond.

Adhesives of the present invention contain at least one benzoxazine-containing compound. Preferably, the adhesive contains less than 80%, and even more preferably less than 70%, of the benzoxazine-containing compound, based on the dry weight of the adhesive. Exemplary embodiments comprise about 30 to about 60% of the benzoxazine-containing compound, based on the dry weight of the adhesive. Other embodiments comprise about 40 to about 50% of the benzoxazine-containing compound, based on the dry weight of the adhesive.

Benzoxazines useful in the present invention are described in U.S. Pat. No. 7,157,509 and U.S. Pat. No. 6,743,852, as well as U.S. Patent Application Publication No. 2007/0129509, the entireties of which are incorporated herein by reference. For example, suitable benzoxazines include those of the following Formula I:

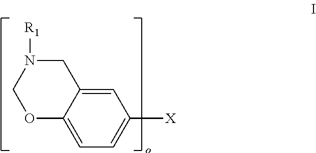

wherein o is 1 4, X is a direct bond (when o is 2), alkyl (when o is 1), alkylene (when o is 24), carbonyl (when o is 2), thiol (when o is 1), thioether (when o is 2), sulfoxide (when o is 2), or sulfone (when o is 2), and R₁ is alkyl.

Other benzoxazines include those of Formula II:

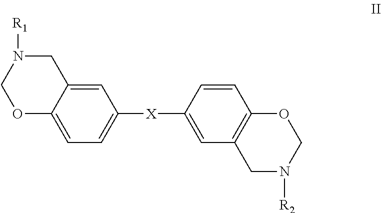

wherein X is a direct bond, CH₂, C(CH₃)₂, CO═S, S═O and O═S═O, and R₁ and R₂ are the same or different and are methyl, ethyl, propyl or butyl.

In other preferred embodiments, the benzoxazine is a compound of Formula III:

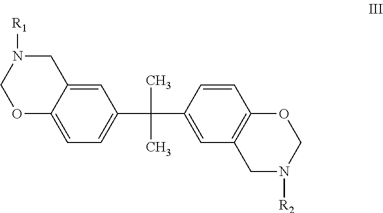

wherein R₁ and R₂ are the same or different and are methyl, ethyl, propyl or butyl.

In still other embodiments, the benzoxazine is of Formula IV:

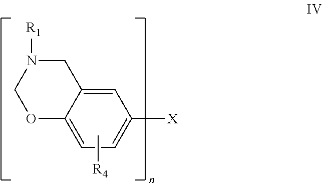

wherein o is 1-4, X is selected from the group consisting of the group consisting of a direct bond (when o is 2), alkyl (when o is 1), alkylene (when o is 2-4), carbonyl (when o is 2), thiol (when o is 1), thioether (when o is 2), sulfoxide (when o is 2), and sulfone (when o is 2), R₁ is selected from the group consisting of hydrogen, alkyl, and aryl, and R₄ is selected from hydrogen, halogen, alkyl, and alkenyl.

In yet other embodiments, the benzoxazine is of Formula V:

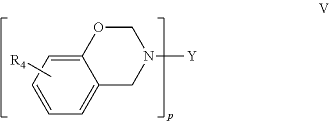

wherein p is 2, Y is selected from the group consisting of biphenyl (when p is 2), diphenyl methane (when p is 2), diphenyl isopropane (when p is 2), diphenyl sulfide (when p is 2), diphenyl sulfoxide (when p is 2), diphenyl sulfone (when p is 2), and diphenyl ketone (when p is 2), and R.sub.4 is selected from the group consisting of hydrogen, halogen, alkyl and alkenyl.

Other preferred embodiments include the following structures:

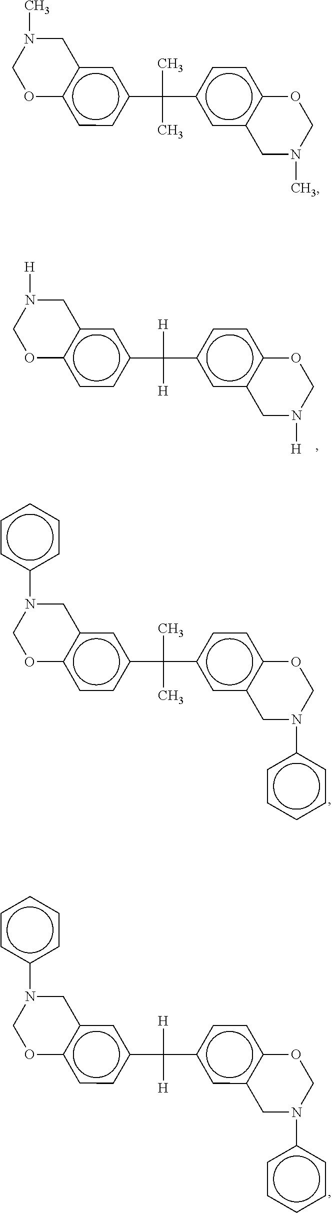

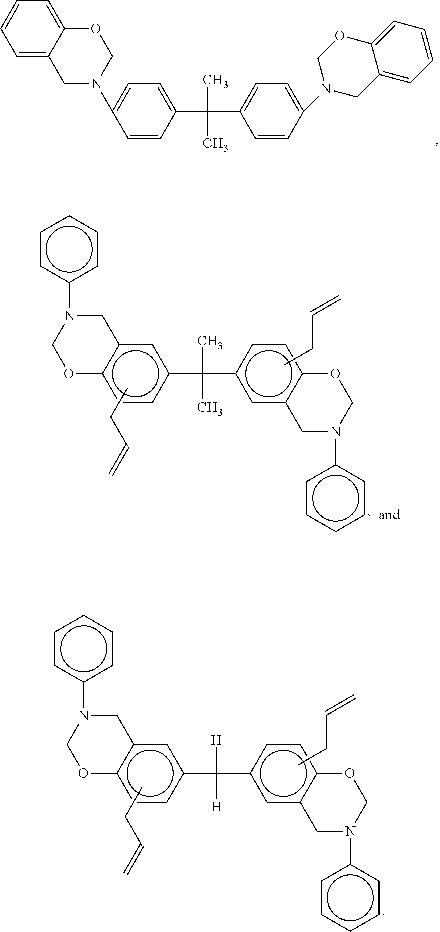

In yet other embodiments are those benzoxaines of Formula VI:

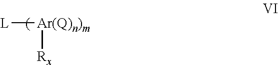

wherein L is an optional alkylene or siloxane linking moiety, Ar is optionally substituted arylene, Q is an oxazine ring or amine salt thereof having the structure

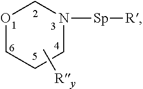

and is bonded to Ar in a fused manner at positions 5 and 6 of the oxazine ring, wherein: Sp is optional, and if present, is a C₁ to C₆ alkylene, oxyalkylene, thioalkylene, carboxyalkylene, amidoalkylene, or sulfonatoalkylene spacer, n is 1 or 2, in is 1 or 2, x and y are each independently 0 to 4, and wherein at least one of R, R′, or R″ is a polymerizable moiety, for example, a moiety independently selected from the group consisting of optionally substituted oxyalkenyl, alkynyl, cycloalkenyl, bicycloalkenyl, styryl, (meth)acrylate, itaconate, maleimide, vinyl ester, epoxy, cyanate ester, nitrile, diallyl amide, benzocyclobutene, aromatic propargyl ether, aromatic acetylene and oxazoline, and the remainder of R, R′ and R″ is(are) independently hydrogen, alkyl or alkoxy.

As employed herein, particularly as it relateds to Formula VI, “arylene” refers to aromatic groups having in the range of 6 up to 14 carbon atoms and “substituted arylene” refers to arylene groups further bearing one or more substituents selected from hydroxy, alkyl, alkoxy, mercapto, cycloalkyl, substituted cycloalkyl, heterocyclic, substituted heterocyclic, aryl, substituted aryl, heteroaryl, substituted heteroaryl, aryloxy, substituted aryloxy, halogen, cyano, nitro, nitrone, amino, amido, C(O)H, acyl, oxyacyl, carboxyl, carbamate, sulfonyl, sulfonamide, sulfuryl, and the like.

“Alkylene” refers to divalent hydrocarbyl radicals having 1 up to 20 carbon atoms, preferably 2-10 carbon atoms, and “substituted alkylene” refers to alkylene moieties bearing one or more of the substituents as set forth above.

“Oxyalkylene” refers to an alkylene moiety wherein one or more of the carbon atoms have been replaced by oxygen atoms, and “substituted oxyalkylene” refers to an oxyalkylene moiety further bearing one or more of the substituents as set forth above.

“Thioalkylene” refers to an alkylene moiety wherein one or more of the carbon atoms have been replaced by sulfur atoms, and “substituted thioalkylene” refers to an thioalkylene moiety further bearing one or more of the substituents as set forth above.

“Carboxyalkylene” refers to an alkylene moiety wherein one or more of the carbon atoms have been replaced by a carboxyl group, and “substituted carboxyalkylene” refers to a carboxyalkylene moiety further bearing one or more of the substituents as set forth above.

“Amidoalkylene” refers to an alkylene moiety wherein one or more of the carbon atoms have been replaced by an amido group, and “substituted amidoalkylene” refers to an amidoalkylene moiety further bearing one or more of the substituents as set forth above.

“Sulfonatoalkylene” refers to an alkylene moiety wherein one or more of the carbon atoms have been replaced by a sulfonato group, and “substituted sulfonatoalkylene” refers to a sulfonatoalkylene moiety further bearing one or more of the substituents as set forth above.

“Polymerizable moiety” refers to any substituent that can participate in polymerization reaction, such as, for example, an addition polymerization or a condensation polymerization. As employed herein, addition polymerization refers to polymerization mechanisms such as free-radical polymerization, anionic polymerization, cationic polymerization, ring-opening polymerization, or coordinative polymerization. As employed herein, condensation polymerization refers to polymerizations such as siloxane polymerization.

In one aspect of the invention, the polymerizable moiety participates in an addition polymerization. Preferred addition polymerizable moieties include, for example, optionally substituted alkenyl, oxyalkenyl, alkynyl, cycloalkenyl, bicycloalkenyl, styryl, (meth)acrylate, itaconate, maleimide, vinyl ester, epoxy, cyanate ester, nitrile, diallyl amide, benzocyclobutene, aromatic propargyl ether, aromatic acetylene, oxazoline, and the like. Most preferred addition polymerizable moieties include alkenyl, oxyalkenyl, (meth)acrylate, maleimide, or cycloalkenyl.

As employed herein, “alkyl” refers to hydrocarbyl radicals having 1 up to 20 carbon atoms, preferably 2-10 carbon atoms; and “substituted alkyl” comprises alkyl groups further bearing one or more substituents selected from hydroxy, alkoxy (of a lower alkyl group), mercapto (of a lower alkyl group), cycloalkyl, substituted cycloalkyl, heterocyclic, substituted heterocyclic, aryl, substituted aryl, heteroaryl, substituted heteroaryl, aryloxy, substituted aryloxy, halogen, trifluoromethyl, cyano, nitro, nitrone, amino, amido, C(O)H, acyl, oxyacyl, carboxyl, carbamate, sulfonyl, sulfonamide, sulfuryl, and the like.

“Alkenyl” refers to straight or branched chain hydrocarbyl groups having at least one carbon—carbon double bond, and having in the range of about 2 up to about 12 carbon atoms, and “substituted alkenyl” refers to alkenyl groups further bearing one or more substituents.

“Alkoxy” refers to the moiety —O-alkyl-, wherein alkyl is as defined above, and “substituted alkoxy” refers to alkoxy groups further bearing one or more substituents as set forth above.

“Alkynyl” refers to straight or branched chain hydrocarbyl groups having at least one carbon—carbon triple bond, and having in the range of about 2 up to about 12 carbon atoms, and “substituted alkynyl” refers to alkynylene groups further bearing one or more substituents as set forth above.

“Cycloalkyl” refers to cyclic ring-containing groups containing in the range of about 3 up to about 8 carbon atoms, and “substituted cycloalkyl” refers to cycloalkyl groups further bearing one or more substituents as set forth above.

“Cycloalkenyl” refers to cyclic ring-containing groups containing in the range of about 3 up to about 8 carbon atoms and having at least one carbon—carbon double bond, and “substituted cycloalkenyl” refers to cycloalkenyl groups further bearing one or more substituents as set forth above.

“Aryl” refers to aromatic groups having in the range of 6 up to about 14 carbon atoms and “substituted aryl” refers to aryl groups further bearing one or more substituents as set forth above.

“Heteroaryl” refers to aromatic groups containing one or more heteroatoms (e.g., N, O, S, or the like) as part of the ring structure, and having in the range of 6 up to about 14 carbon atoms.

“Heterocyclic” refers to cyclic (i.e., ring-containing) groups containing one or more heteroatoms (e.g., N, O, S, or the like) as part of the ring structure, and having in the range of 3 up to 14 carbon atoms and “substituted heterocyclic” refers to heterocyclic groups further bearing one or more substituents as set forth above.

In another aspect of the invention, the polymerizable moiety participates in a condensation polymerization. Preferred condensation polymerizable moieties include, for example, siloxanes.

In a preferred embodiment, the following benzoxazine-containing compound, herein referred to as compound 5, may be used in connection with the present invention:

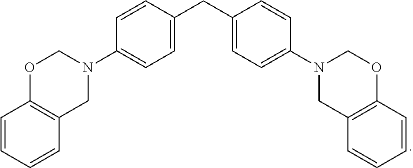

Adhesives within the scope of the present invention may further comprise additives that can attenuate the mechanical, physical, and/or chemical properties of the adhesive. Additives such as carbon black, elastomers (for example, nitrile rubbers), epoxy resins, phenoxy resins, pigments, rheological additives, antioxidants, or a combination thereof, can be included in the adhesive composition.

The adhesives of the present invention may also include a solvent carrier or vehicle, for example, any solvent that provides a phase stable mixture. Suitable solvents include ketones, for example, acetone and methyl ethyl ketone, aromatics, for example toluene and xylenes, and acetate solvents, for example n-butyl acetate. But in the most preferred embodiments, no solvent carrier or vehicle is added, i.e. the adhesives are solventless. The adhesives of the present invention may also be provided as a dispersion in water.

The present invention is further directed to methods for adhering a material to a substrate in a vehicle component, in particular, a brake component such as a shim or brake pad. For example, the present invention relates to a method for adhering a friction material to a substrate to form a friction element that may be used in a friction assembly, such as a vehicle friction assembly, for example a brake component. In one embodiment, a friction material may be adhered to a metal substrate to form a brake pad. The use of a benzoxazine containing adhesive provides such a friction element with superior shear strength at high temperatures especially compared to prior-art nitrile-phenolic adhesives.

Additionally, the present invention relates to a method for adhering a damping material to a metal plate in need of dampening. For example, the benzoxazine-containing adhesives of the present invention can be used to adhere, for example, the rubber of a shim to a vehicle brake component, such as the metal plate of a brake pad. The use of a benzoxazine containing adhesive provides such a shim with superior strength at high temperatures, and over a longer period of time, especially compared to prior-art nitrile-phenolic adhesives. In addition, elastomeric materials can be added to the adhesives of the present invention, in the amounts typically used in the phenolic-based resin, and the high bond strength of the present adhesives is retained after exposure to high temperatures.

The adhesive may be applied to the material, the substrate, or both, and may be applied using any of the methods generally known in the art. Suitable application methods include spray coating, curtain coating, roll application, dip application, or brush application. The adhesive may also be applied in any form suitable for the desired application using any forms known in the art. For example, the adhesive can be applied as a liquid, a hot melt, transfer film, powder, powder slurry, or a solid.

Typically, the material or substrate is contacted with an adhesive comprising a benzoxazine-containing compound and the material and substrate are then contacted. The contacted material and substrate are exposed to heat and pressure sufficient to adhere the adhesive and form a bond between the material and substrate. In some embodiments, the heat and pressure are sufficient to substantially cure the adhesive. In other embodiments, the heat and pressure are sufficient to bond the material and the substrate, but insufficient to substantially cure the adhesive.

In certain applications, only pressure sufficient to provide physical contact of the materials to be adhered may be required to effect bonding. In preferred embodiments, a pressure of between about 10 and about 200 psi is sufficient. In other embodiments, about 50 to about 200 psi is sufficient. In still other embodiments, about 10 to about 50 psi, in particular, about 10 to about 20 psi of pressure is sufficient. Temperatures necessary to effect the curing of the adhesive, which in turn results in the bonding of the materials, is between about 160° C. to about 250° C. (320-482° F.).

In some embodiments, application of the adhesive comprises melting the adhesive at a temperature that is at or above the melting point of the adhesive but below the curing temperature of the adhesive. In a typical application, the adhesive is melted at a temperature between about 80° C. to about 120° C. (176-248° F.).

### EXAMPLES

### Example 1

TABLE 1

| Component | Weight (parts by weight) |
|---|---|
| Benzoxazine Resin (compound 5) | 458.6 |
| CY179¹ | 269.3 |
| Toughening Agent² | 33.1 |
| Acrylate-based Defoamer³ | 2.0 |
| Silane Coupling Agent⁴ | 4.9 |
| Teco-Sil 325F⁵ | 79.0 |
| GP 3I⁶ | 113.6 |
| Cab-o-sil TS720⁷ | 39.5 |
| Total | 1000.0 |

¹Cycloaliphatic epoxy resin from Huntsman Int'l LLC,
²Reaction product of diamino-diphenyl sulfone, digylicylether of bis-phenol A, and Hycar rubber CTBN 1300X13
³Byk A 501 from Byk Chemie
⁴Glycidoxypropyltrimethoxy Silane
⁵Fused Silica from CE-Minerals
⁶Fused Silica from ANH Refractories Company
⁷Treated Fumed Silica from Cabot

The benzoxazine resin was warmed to liquid state and the other components were added in the order shown in Table 1 above under dry atmosphere and mixed to a uniform state. The mixture was pressed to form a film on release paper at a weight of 24 mg/cm².

### Example 2

TABLE 2

| Component | Weight (parts by weight) |
|---|---|
| Inchemrez LER-HH¹ | 5.4 |
| Benzoxazine Resin | 4.7 |
| (compound 5) | |
| Cab-o-sil M5² | 0.8 |
| Cab-o-sil M720³ | 0.2 |
| Total | 11.1 |

¹Blend of phenoxy resin in liquid epoxy resin from Inchem
²Untreated Fumed Silica from Cabot
³Treated Fumed Silica from Cabot

Components shown in Table 2 were combined and warmed for 15 minutes in a 100° C. oven after which they were mixed warm at 2000 RPM on a speedmixer until uniform. The mixture was pressed on a heated carver press between two sheets of release paper (below reaction temperature) to yield a transfer film.

### Example 3

Steel bars of dimensions 1.25″×4″×0.25″ were bonded to 1 in² steel disks of comparable thickness as a means to measure bond strength. The steel bars and disks were solvent cleaned followed by grit blasting with 60 mesh aluminum oxide. A single layer of adhesive films prepared in accordance with Examples 1 and 2 were placed between the grit-blasted sides of the disks and bars. The disks and bars were placed in a fixturing device under a compressive load of 50 psi. The fixture was placed in an oven at 217° C. for a period of 60 minutes over which time curing occurred.

### Comparative Examples 4 and 5

PL-605 (Comparative Example 4) and PL-700 (Comparative Example 5), represent two solvent-borne phenolic resin-based brake adhesives, commercially available from Henkel Corp. Each was applied to solvent cleaned, grit-blasted buttons and bars and dried of solvent (1 hour at 100° C.) yielding a dry thickness of approximately 3 mil. Coated buttons were placed face to face in a fixturing device under applied load (100 psi applied load for PL605, 200 psi applied load for PL700) and thermally cured for 1 hour at 217° C. Compressive shear strength was measured at 25° C. and 204° C. for bonded buttons/bars per SAEJ840. Data is shown in Table 3.

TABLE 3

| | Shear Stength at | Shear Strength at |
|---|---|---|
| Example | 25° C. psi* | 204° C. psi* |
| Example 1 | 4404 | 3452 |
| Example 2 | 6098 | 2846 |
| Comparative Example 4 | 3750 | 500 |
| Comparative Example 5 | 2000 | 500 |

*Lbs./sq. inch

### Example 7

A turbid solution of nitrile rubber was prepared by mixing 100 parts Nipol 1001LG with 460 parts methyl ethyl ketone for sufficient time to reach a uniform liquid.

### Example 8 and 8A

TABLE 4

| Material | Weight (parts by weight). |
|---|---|
| Example 7 | 24.5 |
| Agerite Resin D¹ | 0.14 |
| Benzoxazine Resin | 5.6 |
| (compound 5) | |
| Inchemrez SER-25² | 0.8 |
| Epon 1002³ | 1.2 |
| Methyl ethyl ketone | 10.0 |
| Monarch 120⁴ | 0.5 |
| Total | 42.7 |

¹An antioxidant from R.T. Vanderbuilt
²A 75:25 weight ratio of solid epoxy resin and phenoxy resin available from Inchem
³A solid epoxy resin available from Hexion
⁴A black pigment from Cabot

TABLE 4A

| Material | Weight (parts by weight). |
|---|---|
| Example 7 | 24.5 |
| Agerite Resin D¹ | 0.14 |
| Benzoxazine Resin | 5.2 |
| (compound 5) | |
| Inchemrez SER-25² | 1.2 |
| Epon 1007³ | 1.2 |
| Methyl ethyl ketone | 10.0 |
| Monarch 120⁴ | 0.5 |
| Total | 42.7 |

¹An antioxidant from R.T. Vanderbuilt
²A 75:25 weight ratio of solid epoxy resin and phenoxy resin available from Inchem
³A solid epoxy resin available from Hexion
⁴A black pigment from Cabot

All ingredients shown in Tables 4 and 4A were combined and mixed sufficiently to form uniform black adhesives (Example 8 and 8A, respectively).

### Comparative Example 9

PL-686 represents a solvent-borne phenolic resin-based adhesive, commercially available from Henkel.

### Example 10

Adhesives from Example 8, Example 8A and Comparative Example 9 were applied to brake shims (rubber coated steel sheet) at a wet film thickness of 15 mil after which the coated sheets were dried of solvents. The dried coated sheet was then cut into 1″×4″ strips and bonded to a steel backing plate of ¼ inch thickness. The surface of the steel was grit-blasted with 60 mesh aluminum oxide grit shortly before bonding. Bonding was carried out using a heated Carver press with platen temperature of 232° C. with applied load of 600 psi for a duration of 1 minute.

### Example 11

90-degree peel strength of bonded parts was determined at 25° C. with and without exposure to high temperature. Heat conditioning was carried out by placing bonded parts in an oven at 250° C. for a period of 30 minutes. Results are shown in Table 5.

TABLE 5

| | Peel | Peel Strength after Heat |
|---|---|---|
| | Strength (P.L.I.)* | Conditioning (P.L.I.)* |
| Example 8 | 58.3 | 31.8 |
| Example 8A | 66.2 | 65.5 |
| Comparable Example 9 | 9.5 | 5.5 |

*Pull speed of 2 inches/minute, Lbs./linear Inch

When ranges are used herein, such as for weight percent of compositions, temperature, or shear strength, all combinations and subcombinations of ranges and specific embodiments therein are intended to be included.

What is claimed:

1. A vehicle friction assembly comprising a friction material adhered to a substrate with an adhesive, the adhesive comprising a benzoxazine-containing compound, wherein the adhesive exhibits a shear strength of at least about 1500 psi at about 204° C.

2. The vehicle friction assembly of claim 1, wherein the benzoxazine-containing compound is

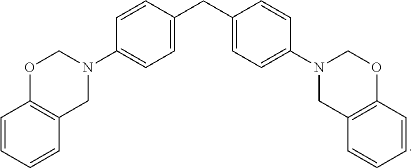

3. The vehicle friction assembly of claim 1, wherein the ratio of the shear strength of the adhesive at 204° C. to the shear strength of the adhesive at 21° C. is greater than 0.4.

4. The vehicle friction assembly of claim 1, wherein the adhesive contains less than about 80%, by weight of the dry adhesive, of the benzoxazine-containing compound.

5. The vehicle friction assembly of claim 1, wherein said substrate is a metal plate and the assembly comprises a brake pad or brake shoe.

6. The vehicle friction assembly of claim 1, wherein the friction material comprises ceramic, metal, resin, asbestos, or a combination thereof.

7. A method of adhering a friction material to a substrate, the method comprising:
applying to the friction material or the substrate an adhesive comprising a benzoxazine-containing compound;
contacting the substrate to the friction material such that the substrate or friction material contacts at least a portion of the benzoxazine-containing adhesive;
exposing the contacted friction material and substrate to heat, time, and pressure sufficient to cure the adhesive between the material and substrate and form a friction assembly,
and wherein the adhesive exhibits a shear strength of at least about 1500 psi at about 204° C.

8. The method of claim 7, wherein the benzoxazine-containing compound is

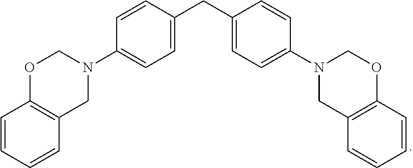

9. The method of claim 7, wherein the ratio of the shear strength of the adhesive at 204° C. to the shear strength of the adhesive at 21° C. is greater than 0.4.

10. The method of claim 7 wherein the pressure applied to the material is between about 20 psi to about 200 psi, said pressure being applied in the direction of the substrate.

11. The method of claim 7, wherein the friction material comprises ceramic, metal, resin, asbestos, or a combination thereof.

12. The method of claim 7 wherein the adhesive is applied without a solvent vehicle.

13. The method of claim 7 wherein the substrate is a metal plate and the assembly comprises a brake pad or brake shoe.

14. A method of bonding a brake shim to a substrate, wherein the brake shim comprises a rubber coated metal, the method comprising:
applying to the rubber of the shim or to the substrate an adhesive comprising a benzoxazine-containing compound;
contacting the rubber to the substrate, such that the adhesive is between the rubber and the substrate, and
exposing, at a first place and/or point in time, the contacted rubber and substrate to heat, time, and pressure sufficient to bond the rubber to the substrate but insufficient to substantially cure the adhesive.

15. The method of claim 14, wherein the benzoxazine-containing compound is

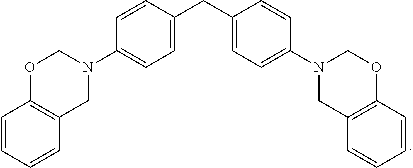

16. The method of claim 14 wherein the adhesive exhibits a peel strength of about 20 to about 75 PLI at about 21° C.

17. The method of claim 14 further comprising exposing the bonded brake shim to heat, time, and/or pressure that results in further curing of the adhesive at a second place and/or point in time, and wherein the adhesive exhibits a peel strength of about 20 to about 75 PLI at about 21° C. after such further exposure.

18. The method of claim 14 wherein the substrate is the metal backing plate of a brake assembly.

19. A brake shim adhered to a metal plate with an adhesive, the adhesive comprising a benzoxazine-containing compound, wherein the adhesive exhibits a peel strength of about 20 to about 75 PLI at about 21° C.

20. The brake shim of claim 19, wherein the benzoxazine-containing compound is [chemical structure]
